(19) United States
(12) Patent Application Publication
(10) Pub. No.: US 2022/0198589 A1
(43) Pub. Date: Jun. 23, 2022

(54) SYSTEM AND METHOD FOR ACCESS TO AND SALES OF REAL ESTATE PROPERTY

(71) Applicants: Brooke Wyatt, Indianapolis, IN (US); Mark Papandreas, Jupiter, FL (US); Lucinda Papandreas, Jupiter, FL (US); Emanuel Papandreas, Indianapolis, IN (US)

(72) Inventors: Brooke Wyatt, Indianapolis, IN (US); Mark Papandreas, Jupiter, FL (US); Lucinda Papandreas, Jupiter, FL (US); Emanuel Papandreas, Indianapolis, IN (US)

(73) Assignee: BEXA360 LLC, Indianapolis, IN (US)

(21) Appl. No.: 17/561,464

(22) Filed: Dec. 23, 2021

Related U.S. Application Data
(60) Provisional application No. 63/130,126, filed on Dec. 23, 2020.

(51) Int. Cl. G06Q 50/16

(52) U.S. Cl. CPC G06Q 50/163

(57) ABSTRACT

A system and method is disclosed by which a requesting individual's identity can be verified prior to scheduling a property tour on real properties. The subsequent access, arrival and departure from the real properties can be monitored and relayed in real time to property owners or their representatives and managed by the use of geolocation systems. Data from property visitations can be collected and aggregated to facilitate sales and rentals of real property.

### RELATED APPLICATIONS

This application is a non-provisional of U.S. Provisional Patent Application Ser. No. 63/130,126, filed Dec. 23, 2020, the disclosure of which is hereby incorporated by reference in its entirety.

### FIELD OF THE DISCLOSURE

The present disclosure relates to the sales and rental of real estate property, and more particularly to scheduling and monitoring the showing of and access to real estate property for sales and rentals.

### BACKGROUND

Systems currently used to facilitate showing requests do not have the ability to verify the identity of prospective clients who wish to view a property. Agents commonly show properties without knowledge as to who the person viewing the property actually is. Assaults and other attacks are all too commonplace in the industry. The industry standard is to meet a prospective client at the agent's office and obtain a driver's license before going to a property. This protocol is rarely followed due to its inefficiency in today's marketplace and potential client's expectation to immediately see a home. This also does not prevent agents from being attacked at the office when they meet the prospect. Even if the agent gathers identification of the party they are showing, there is no system or industry standard as to the way the identification is stored, who may access it, or how the information is retrievable. The ability to verify the identity of a potential client and the removal of anonymity reduces the chances that someone will try to take advantage of an agent.

Systems currently used do not record the time spent at a property nor is the ability available to see if a prospect has seen homes with another agent prior to showing that same prospect a home. This leaves the agent at a disadvantage with some prospects that have contracts in place with other agents and may misrepresent the fact that they are already working with another agent.

Real estate applications on personal computers and smart phones that are currently in use to secure property employ a system specific electronic lockbox that communicates with the host system to allow access to the building for a showing. Electronic lockbox systems are not always used as they are cumbersome, expensive to employ and not always reliable due to weather or battery issues. Manual lock boxes that employ a combination to open the box that holds a property key are still popular among sellers, landlords and real estate agents, because they are inexpensive and reliable but this system has several long-known disadvantages.

Buyer's agents often give lockbox access codes to clients and allow clients to view occupied and unoccupied homes without an agent present. This practice, while frowned upon by the local boards, is still wide-spread and is rarely reported by listing agents due to their willingness to cooperate with other agents. Agents are generally unwilling to go through the lengthy process of reporting other agents that disobey the rules. This practice puts sellers and buyers at risk and brokers have increased E&O liability to sellers by not being able to ensure that a buyer's agent is accompanying individuals on tours of their listings.

Real estate applications for use with personal computers and smart phones that currently facilitate the showing process provide emails or texts to buyer's agents with sensitive information about the home's access including lock box codes, alarm codes, times to access which correlate with the seller/owner's absence. Agents have been the target of malicious hackers that monitor the agent's email and this can contribute to theft or personal harm to sellers when access information to real property is not adequately secured.

Currently, when a showing is scheduled on a property, the owner of the home does not know when the agent, buyer or tenant is entering or has departed the property. This results in an inconvenience to the owner as it is customary, industry-wide, for sellers to not be present when the agents and buyers are touring the property. Currently the only way to tell if an agent or buyer have arrived at a property is to install a smart doorbell, camera or electronic lock box. Smart doorbells or cameras are expensive and do not have the ability to determine who has arrived to see the home. In addition, departure notifications are problematic because current lockboxes often rely on the closing of the box or replacement of the key to determine egress. These functions do not in and of themselves, determine egress completely. Agents may still be at the property with their clients long after they've returned the key and closed the lockbox or may be out of camera view.

Electronic lockboxes in use today have a security feature inhibiting licensed individuals who have access to the boxes. This process requires a call from the authorized individual to the owner requesting a special code that is requested to open the lockbox or putting a timer on the scheduled showing location's lockbox. These are additional steps are seldom used by agents because of the time it takes to call and request the code or the time it takes to institute the timer feature on the box. This results in anyone who has permission in the system to open an electronic lockbox to be able to open any lockbox without a scheduled showing simply by opening the box on their phone.

The current showing systems have no automation that will enable an authorized user to send a request to an owner if the authorized user is running late and needs more time for a showing, and rely heavily on agent participation to press a button on their mobile device when they leave a property for a checkout. Unfortunately, agents do not participate in the checkout process as they are simply too busy and consumed with other tasks at the time of departure and the checkout does not benefit them or their client.

The current system for short-term rental checkin and checkout is virtually non-existent. The only way an owner knows if a tenant has vacated the premises is to go to the property to ensure the tenant has left.

Therefore, a need exists to protect the seller's private access and alarm information. A need exists to ensure that an authorized user (such as and real estate agent) approved to show a property actually accompanies their party to the property. A need exists to alert the seller as to when people arrive and depart their home that does not rely on home protection equipment, on any particular type of lock box, or on the actions of the authorized user. A need exists for an agent to be able to identify whom he or she is meeting in the field prior to the event and a need for that information to be held securely and where applicable, confidentially. A need exists for an authorized user to communicate to the owner when the authorized user is running late or otherwise needs to request an extension of time for a showing that also enables the owner to approve or decline the time extension, or the late arrival, departure, checkin or checkout time. A need exists to determine if a short-term tenant has vacated a property without having to go to the property to verify. A need exists to hide what kind of lockbox is on the home and the access information to get in until the agent physically arrives at a the scheduled time.

Embodiments of this system and method can solve some or all of these long held collective problems of the seller and the listing agent protection while preserving the practice of buyer anonymity where applicable. Additional advantages and other novel features will be set forth in part in the description and drawings that follow and in part will become apparent to those skilled in the art upon examination of the following or may be learned with the practice of the technology disclosed herein. The present disclosure is to be considered a disclosure of exemplary embodiments of the invention, and is not intended to limit the invention to the specific embodiments illustrated by the figures or described below.

### SUMMARY

A property access system is disclosed for monitoring access to real property. The system comprises a server system, and a local or mobile application on a mobile electronic device with a Global Positioning System (GPS) locator. The mobile electronic device is assigned to an authorized user. The GPS locator provides GPS location readings. The system schedules an access time for the authorized user to access the property. The system sends access information for the property to the mobile application, and the mobile application notifies the system when the mobile electronic device arrives at the property and departs from the property based on the GPS location readings.

One or more geofences can be established around the property, and the mobile application can notify the system when the mobile electronic device arrives at the property and departs from the property based on when the GPS location readings indicate that the mobile electronic device crosses into or out of the geofence. The system can send a notification when the mobile electronic device arrives at the property and departs from the property. The mobile application can keep the access information for the property hidden until the GPS location readings indicate that the mobile electronic device has arrived at the property. The mobile application can keep the access information for the property hidden until the current time is within a predetermined window around the access time for the authorized user to access the property. The mobile application can delete the access information for the property when the GPS location readings indicate that the mobile electronic device has departed from the property. The mobile application or the system can check whether the authorized user has arrived at the property at the scheduled access time; and when the authorized user has not arrived at the property at the scheduled access time, the mobile application or the system can request the authorized user to confirm whether they are still coming to access the property, reschedule access to the property or cancel access to the property.

The system can include a new user interface that accepts user provided information from a new user, and a verification module that extracts identifying information from the user provided information and retrieves additional identifying information for the new user based on the extracted identifying information. The system can send the identifying information to an owner, and enable the owner to choose whether to authorize the new user, and if authorized to schedule an access time for the new authorized user to access the property.

A property access method is disclosed for monitoring access to real property. The method includes scheduling an access time for an authorized user to access the property; tracking a location of the authorized user using a Global Positioning System (GPS) locator on a mobile electronic device assigned to the authorized user; sending access information for the property to the mobile electronic device assigned to the authorized user; notifying a base system when the mobile electronic device arrives at the property based on GPS location readings from the GPS locator on the mobile electronic device; and notifying the system when the mobile electronic device departs from the property based on the GPS location readings.

The property access method can also include establishing a geofence around the property. Notifying the system when the mobile electronic device arrives at the property can include notifying the system when the GPS location readings indicate the mobile electronic device has crossed into the geofence. Notifying the system when the mobile electronic device departs from the property can include notifying the system when the GPS location readings indicate the mobile electronic device has crossed out of the geofence.

The property access method can also include sending a notification from the system when the mobile electronic device arrives at the property and departs from the property. The property access method can also include hiding the access information for the property on the mobile electronic device until the GPS location readings indicate that the mobile electronic device has arrived at the property. The property access method can also include hiding the access information for the property on the mobile electronic device until the current time is within a predetermined window around the access time for the authorized user to access the property. The property access method can also include deleting the access information for the property from the mobile electronic device when the GPS location readings indicate that the mobile electronic device has departed from the property.

The property access method can also include checking whether the authorized user has arrived at the property at the scheduled access time; and when the authorized user has not arrived at the property at the scheduled access time, requesting the authorized user to confirm they are still coming to access the property, reschedule access to the property or cancel access to the property.

The property access method can also include accepting user provided information from a new user; extracting identifying information from the user provided information; retrieving additional identifying information for the new user based on the extracted identifying information. The property access method can also include sending the identifying information to an owner, and enabling the owner to choose whether to authorize the new user, and if authorized to schedule an access time for the new authorized user to access the property.

A property access method is disclosed for monitoring access to real property. The method includes scheduling a checkin time and a checkout time for an authorized user to access the property; tracking a location of the authorized user using a Global Positioning System (GPS) locator on a mobile electronic device assigned to the authorized user; sending entry information for the property to the mobile electronic device assigned to the authorized user when the current time is at or after the checkin time, and the mobile electronic device has arrived at the property based on GPS location readings from the GPS locator on the mobile electronic device; notifying a system when the mobile electronic device arrives at the property based on GPS location readings from the GPS locator on the mobile electronic device; allowing the mobile device to stop monitoring the authorized user's location; sending checkout information for the property to the mobile electronic device assigned to the authorized user prior to the checkout time; removing entry information for the property from the mobile electronic device assigned to the authorized user when the current time is at or after a predetermined time after the checkout time, and/or the mobile electronic device has departed from the property based on GPS location readings from the GPS locator on the mobile electronic device; and notifying the system when the mobile electronic device departs from the property based on the GPS location readings and ending the monitoring of the authorized user's location. The method can also include, at checkout time, determining whether the authorized user has departed from the property based on GPS location readings from the GPS locator on the mobile electronic device; and if the authorized user has not departed from the property, sending a checkout reminder for the property to the mobile electronic device assigned to the authorized user, and notifying the system that the authorized user has not departed from the property.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1. illustrates an exemplary flow diagram for identification of a potential client or individual through the system;

FIG. 2. illustrates an exemplary flow diagram of the initial process of monitoring the authorized user's mobile device;

FIG. 3. illustrates an exemplary flow diagram for arrival of an authorized user and dissemination of private access information;

FIG. 4. illustrates an exemplary flow diagram for departure of an authorized user, removal of access information and the termination of location monitoring;

FIG. 5. illustrates an exemplary flow diagram for a checkin process for a short term rental property, dissemination of access information and termination of location monitoring;

FIG. 6. illustrates an exemplary flow diagram for a checkout process for a short term rental property prior to or during checkout period and the initiation of location monitoring; and

FIG. 7. illustrates an exemplary flow diagram for a system that preemptively sends a reminder to an authorized user when the system determines that the authorized user has not arrived at a particular property for which the authorized user has been scheduled, and has the authorized user choose whether they would like to cancel the showing, reschedule the showing or simply tell the owner they are running late.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

An owner includes the owner of the property or anyone the owner of the property has given authority to act on their behalf, such as but not limited to, listing agent, property manager, assistant to the owner, its subsidiaries or assigns, etc. The owner of a property for rent or for sale can enter property descriptions and notification information for a property. An authorized user includes anyone who has registered in the system or mobile application to schedule time at a property, including but not limited to, contractors, appraisers, inspectors, real estate agents, buyer's representatives, etc. Agents includes licensed real estate professionals, such as but not limited to, listing agents, buyer's agents, etc. Client or customer can include someone with an established business relationship or representation, as well as someone who does not yet have an established business relationship or representation.

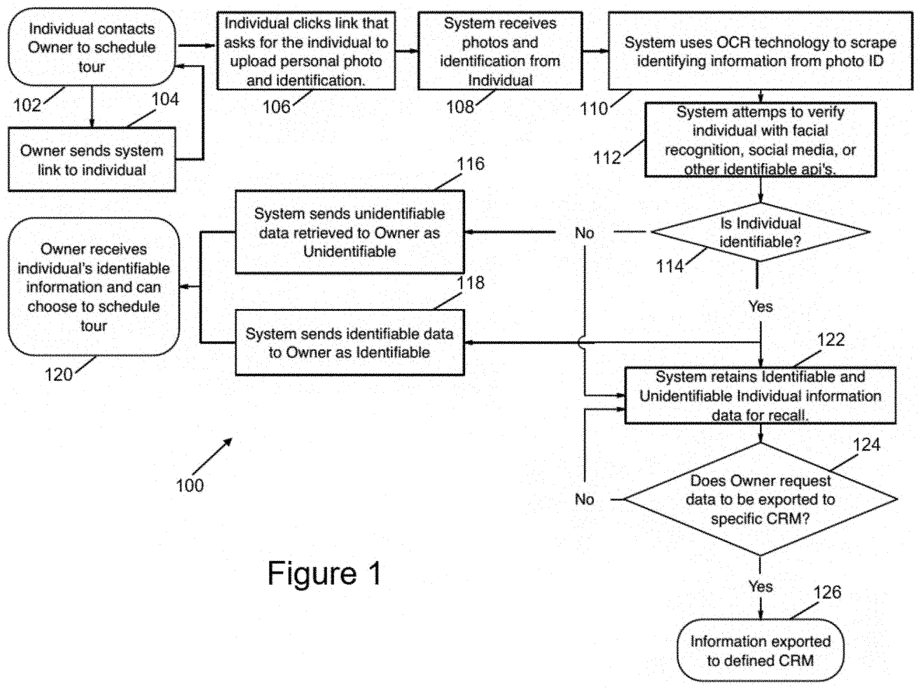

FIG. 1. illustrates an exemplary flow diagram 100 for the identification of a potential client or individual through the system, and an exemplary process is described below. At block 102, a client, potential client or customer communicates to an agent or owner of a property that they would like to schedule a tour of the property. At block 104, the agent or owner may send a link from the system or mobile application to the client that will enable the client to provide identifying information. At block 106, the client enters their identifying information into the system or mobile application, which can require the prospective client to take a picture of themselves, and their driver's license or other photo ID and upload those photos through prompts in the system or mobile application.

At block 108, the system receives the identifying information from the prospective client. At block 110, the system can scrape information from the driver's license or other provided information using (optical character recognition) OCR technology, including driver's license number, name and address and other identifying information and store this information in the system. At block 112, the system can use the provided information and can gather other accessible information to compile identifying information to verify a potential client's identity, or the system can simply notify the requesting party that the identification information has been uploaded by the client and stored securely by the system.

At block 114, the system can make a determination as to whether the client is identifiable. If the client is not identifiable, then at block 116 the system can send the gathered information for the client to the owner or agent and indicate that the client was not identifiable. If the client is identifiable, then at block 118 the system can send the gathered information for the client to the owner or agent and indicate that the client was identifiable. Whether or not the client is identifiable, at block 120 the owner or agent can receive and review the gathered information of the client and decide whether to schedule a tour of the property with the client.

Whether or not the client is identifiable, at block 122 the client/prospect/customer (“customer”) is then stored in the system and when the customer sees a property, the property location is listed as having been shown to this customer. The customer is placed into the system's database. If, in the event an agent is injured by a customer or foul play is suspected, the customer's information can be retrievable by the system to aid law enforcement by the owner of the application. In addition, data regarding the homes shown related to a specific customer may be managed and available for recall by licensed real estate agents associated with that customer. Limited data on specific customers may be recalled by all licensed real estate agents, owners using the system for short-term rental scheduling, or for sale by owner listing. At block 124, the system can check whether an owner or agent wants the client and/or showing information exported to a specific client relationship management (CRM) system. If an owner or agent requests the information exported to a specific CRM system, then at block 126 the information is exported from the system's database into the requested CRM system with authorized information.

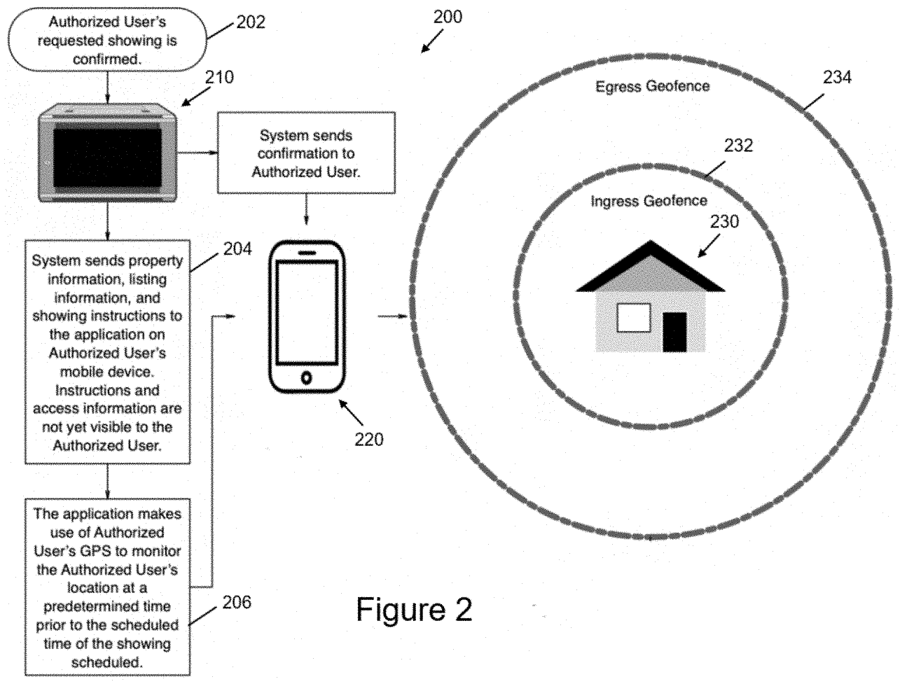

FIG. 2. illustrates an exemplary flow diagram 200 for the system sending listing information to an authorized user and the beginning of monitoring the authorized user's location, and an exemplary process is described below. The flow diagram 200 includes the system 210, an authorized user's GPS enabled electronic device 220 (e.g., smart phone or tablet), and a property 230 with an ingress geofence 232 and an egress geofence 234.

At block 202, the owner or system confirms an authorized user's requested showing of the property 230 with the system 210. At block 202, the system 210 sends property information such as the location of the property 230, specific showing instructions, and private access information to the mobile system engaged on the authorized user's mobile device 220 (such as a mobile application). The mobile application sets the initial positioning of the geofence(s) 232, 234 around the property that is scheduled to be shown. The application on the authorized user's mobile device 220 can be configured to keep the access information or specific showing instructions for the property 230 hidden until the scheduled time and/or when the authorized user is in required proximity of the property 230. At block 206, the application on the authorized user's mobile device 220 can begin monitoring the location of the authorized user at a predetermined time prior to the scheduled showing time to monitor the authorized user's arrival at the property 230.

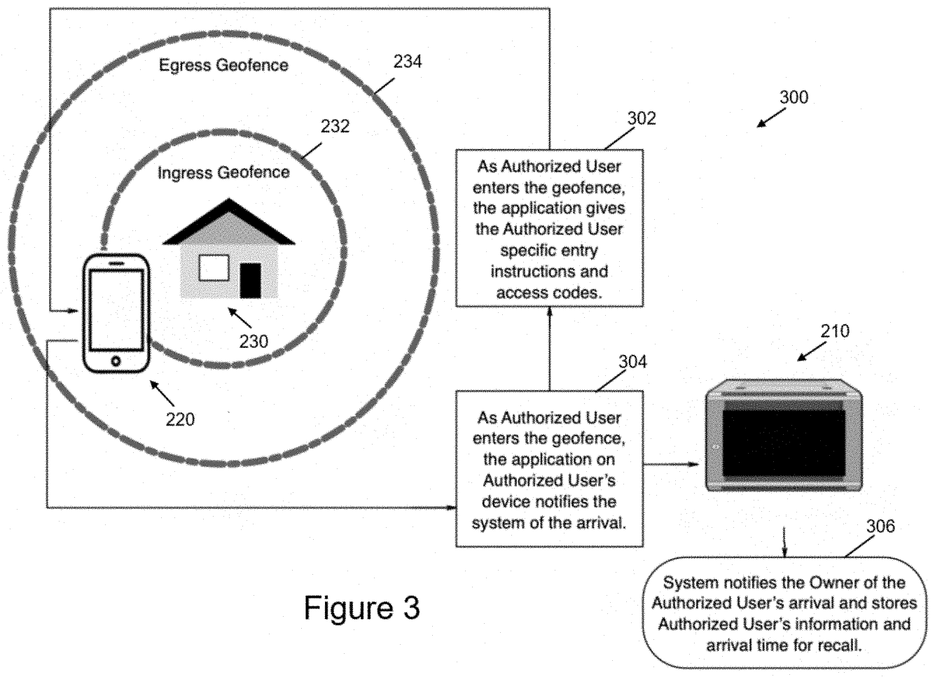

FIG. 3. illustrates an exemplary flow diagram 300 for arrival of an authorized user and dissemination of access information, and an exemplary process is described below. At block 302, the system waits for the mobile device 220 of the authorized user to either cross into the ingress geofence 232, or for the authorized user to open the mobile application on their mobile device 220 inside the ingress geofence 232 or within proximity of the property 230. When the mobile device 220 of the authorized user is detected within the required proximity of the property 230, at block 302 the mobile application displays the confidential access information associated with that property 230 to the authorized user, and at block 304 the mobile application sends an arrival notification to the system 210. At block 306, the system 210 sends an arrival notification to the owner that the authorized individual has arrived at the property 230 and stores the authorized individual's information and arrival time.

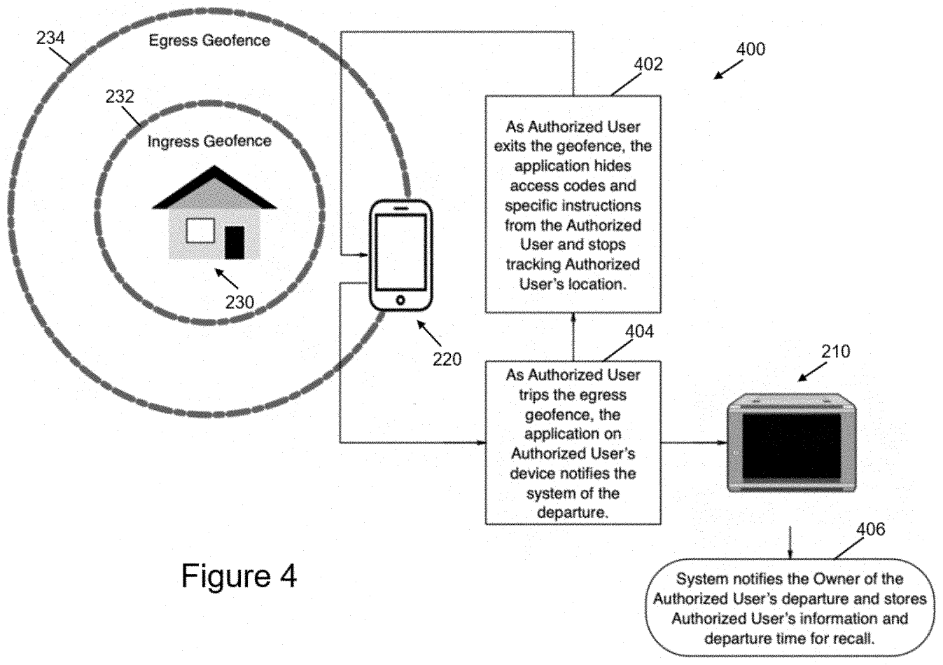

FIG. 4. illustrates an exemplary flow diagram 400 for departure of an authorized user and removal of access information, and an exemplary process is described below. At block 402, the system waits for the mobile device 220 of the authorized user to cross out of the egress geofence 234 or to leave a required proximity of the property 230. If the authorized user has not departed the property after a specific period of time after the time allotment to view the property has passed, then the system can send a delay departure notification. When the authorized user departs the property 230 and crosses the egress geofence 234 upon leaving, at block 402 the mobile application hides the confidential access information associated with that property 230 from the authorized user and stops monitoring the authorized user's location, and also at block 404 the mobile application sends a departure notification to the system 210 to indicate that the showing has ended. At block 406, the system 210 sends a departure notification to the owner that the authorized individual has left the property 230 and stores the authorized individual's information and departure time.

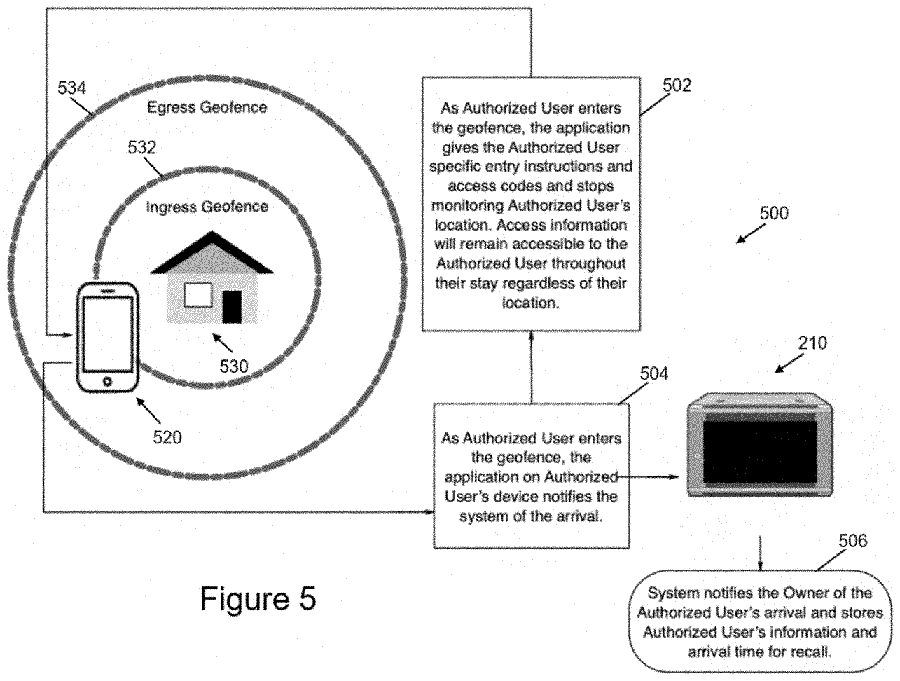

FIG. 5. illustrates an exemplary flow diagram for a checkin process for a short term rental property, and an exemplary process is described below. The flow diagram 500 includes the system 210, an authorized user's GPS enabled electronic device 520 (e.g., smart phone or tablet), and a property 530 with an ingress geofence 532 and an egress geofence 534. An authorized user schedules a showing of the rental property 530 through the system 210 and downloads an application onto their electronic device 520. At block 502, the system waits for the electronic device 520 of the authorized user to either cross into the ingress geofence 532, or for the authorized user to open the application on their electronic device 520 inside the ingress geofence 532 or within proximity of the property 530. When the electronic device 520 of the authorized user is detected within the required proximity of the property 530, at block 502 the application displays the entry instructions associated with that property 230 to the authorized user and stops monitoring the location of the authorized user, and at block 504 the application sends an arrival notification to the system 210. At block 506, the system 210 sends an arrival notification to the owner that the authorized user has arrived at the property 530 and stores the authorized user's arrival time. The authorized user is enabled to retrieve the access information associated with the property 530 throughout the scheduled duration of their stay at the property 530.

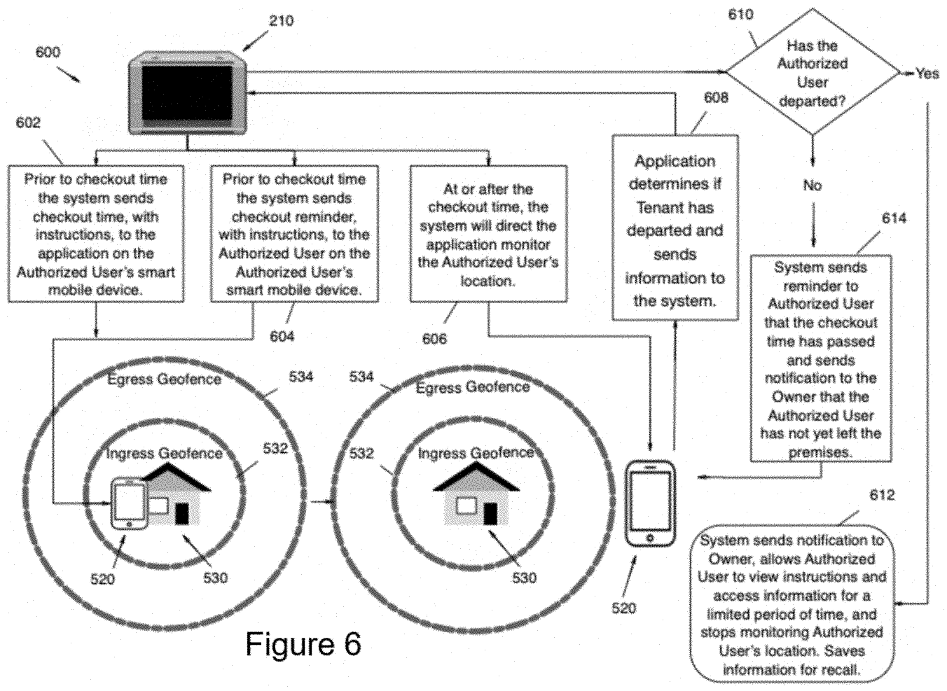

FIG. 6. illustrates an exemplary flow diagram 600 for a checkout process for a short term rental property, and an exemplary process is described below. At block 602, at a predetermined time(s) prior to checkout, the system 210 can send checkout time and checkout instructions to the mobile application on the electronic device 520 of the authorized user. At block 604, at a predetermined time(s) prior to checkout, the system 210 can send notifications, checkout instructions for the property 530 to the electronic device 520 for the authorized user.

At or after the checkout time, at block 606, the system 210 can direct the electronic device 520 of the authorized user to monitor the authorized user's location. At block 608, the application on the electronic device 520 determines whether the authorized user is still within the geofence area(s) 532, 534, and sends the determination to the system 210. At block 610, if the authorized user is not inside the geofence(s) 532, 534, then at block 612 the system 210 can send the owner a notification that the authorized user has departed the property 530. If the authorized user has not departed the property 530, the system 210 can send additional reminders to the authorized user's electronic device 520 that the checkout time has passed, and can notify the owner that the authorized user has not vacated the property 530. The application can allow the authorized user to obtain access information for a predetermined amount of time after the checkout time, just in case the authorized user has left something at the premises and needs to retrieve it prior to final departure. After the predetermined period of time is over, the access information will not be retrievable. Once the system 210 has determined departure, the monitoring of the location of the authorized user can cease.

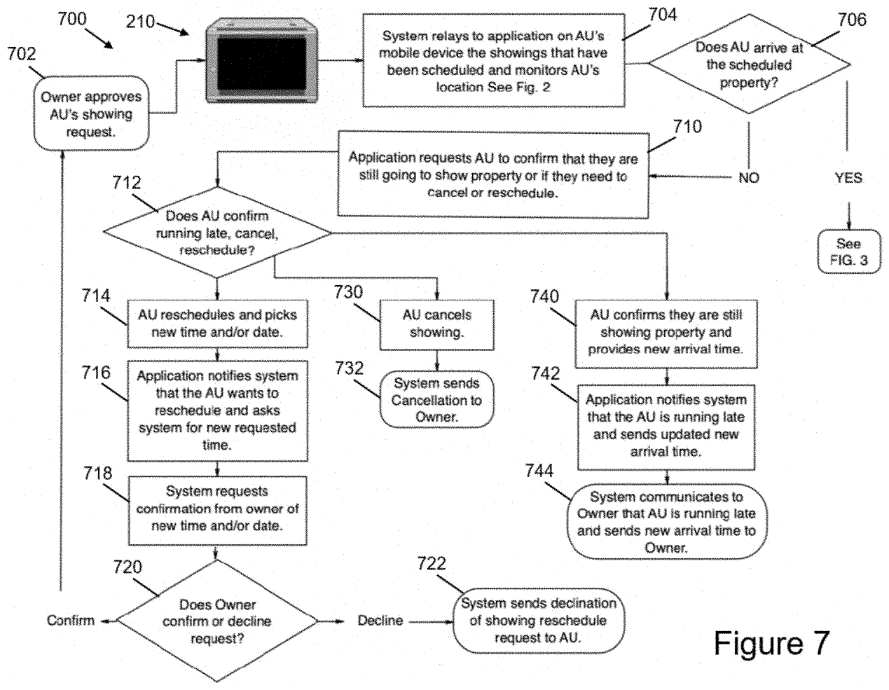

FIG. 7. illustrates an exemplary flow diagram 700 of the request by the system 210 for an update if an authorized user has not arrived at the property within the scheduled time or has skipped a property, an exemplary process is described below. At block 702, the owner can approve a showing request of an authorized user as described with regard to FIG. 2. At block 704, the system 210 sends the scheduled showings to the application on the authorized user's mobile device 220 and can start monitoring the location of the authorized user at a predetermined time prior to a scheduled showing time as described with regard to FIG. 2. At block 706, the system determines whether the authorized user has arrived at the scheduled property. If the authorized user has arrived at the scheduled property, then the system progresses as described with regard to FIG. 3.

If the authorized user has not arrived at a scheduled property or skips a property, then at block 710, the authorized user will be asked what their intentions are for showing the property. At block 712, the authorized user can be asked whether they would like to cancel the showing; reschedule the showing; or if they are running late and if so, what their new arrival time will be.

If at block 712, the authorized user responds that they would like to reschedule the showing, then control passes to block 714. At block 714, the authorized user enters a new time and date when they would like to reschedule the showing. At block 716, the application on the authorized user's mobile device 220 can notify the system 210 that the authorized user would like to reschedule the showing to the selected new time and date. At block 718, the system 210 can request owner approval of the property showing at the selected new time and date. At block 720, the owner can approve or decline the request for the property showing at the selected new time and date. If the owner approves the request, control goes to block 702 where the showing appointment is recorded by the system 210. If the owner declines the request, control goes to block 722 where the system 210 sends a declination notice for the new showing time to the requesting authorized user.

If at block 712, the authorized user responds that they would like to cancel the showing, then control passes to block 730. At block 730, the authorized user sends a cancellation notification for the showing to the system 210. At block 732, the system 210 sends a cancellation notification for the showing to the owner.

If at block 712, the authorized user responds that they are running late for the showing, then control passes to block 740. At block 740, the authorized user confirms that they still plan to show the property and provides a new arrival time. At block 742, the application on the authorized user's mobile device 220 can notify the system 210 that the authorized user is running late and send the new arrival time notification. At block 744, the system 210 can notify the owner that the authorized user is running late and send the new arrival time to the owner.

Since the system can utilize GPS and communication capability on an electronic device of the authorized user to communicate to the host system, and the host system can communicate notifications to the owner/agent, the system can work effectively regardless of what kind of lockbox is utilized at the property. The system uses one or more geofences to determine when the notifications are sent, providing information as to not only when the parties arrive and depart the property, but also allowing data to be collected as to how long the parties/potential buyers were on the property.

This system, while extrapolating data from the visit, has the ability, when using agency between the parties, to anonymize the buyer's information to the seller which has been a long held tradition in the industry while also improving the safety aspect to the owner/agent of the property and the buyer's/renter's agent. The system can deny access to unauthorized individuals or showings that have not been scheduled or confirmed. The system can send reminders to users, and can enable users to request extensions without phone calls or special codes. The system can save and extrapolate data from showings or rental stays for use in the future.

While the disclosure has been illustrated and described in detail in the drawings and foregoing description, such illustration and description is to be considered as exemplary and not restrictive in character, it being understood that illustrative embodiment(s) have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. A property access system for monitoring access to real property, the system comprising:
a local application on a mobile electronic device with a Global Positioning System (GPS) locator, where the mobile electronic device is assigned to an authorized user and the GPS locator is configured to provide GPS location readings;
a base system configured to schedule an access time for the authorized user to access the property;
wherein the base system is configured to send access information for the property to the local application, and the local application is configured to notify the base system when the mobile electronic device arrives at the property and departs from the property based on the GPS location readings.

2. The property access system of claim 1, wherein a geofence is established around the property, and the local application is configured to notify the base system when the mobile electronic device arrives at the property and departs from the property based on when the GPS location readings indicate that the mobile electronic device crosses into or out of the geofence.

3. The property access system of claim 1, wherein the base system is configured to send a notification when the mobile electronic device arrives at the property and departs from the property.

4. The property access system of claim 1, wherein the local application is configured to keep the access information for the property hidden until the GPS location readings indicate that the mobile electronic device has arrived at the property.

5. The property access system of claim 1, wherein the local application is configured to keep the access information for the property hidden until the GPS location readings indicate that the mobile electronic device has arrived at the property, and the current time is within a predetermined window around the access time for the authorized user to access the property.

6. The property access system of claim 1, wherein the local application is configured to delete the access information for the property when the GPS location readings indicate that the mobile electronic device has departed from the property.

7. The property access system of claim 1, wherein a geofence is established around the property; and
wherein the local application is configured to notify the base system when the mobile electronic device arrives at the property based on when the GPS location readings indicate that the mobile electronic device crosses into the geofence, and to notify the base system when the mobile electronic device departs from the property based on when the GPS location readings indicate that the mobile electronic device crosses out of the geofence; and
wherein the base system is configured to send a notification when the mobile electronic device arrives at the property and departs from the property:

8. The property access system of claim 1, wherein the base system is configured to check whether the authorized user has arrived at the property at the scheduled access time; and
when the authorized user has not arrived at the property at the scheduled access time, the local application requests the authorized user to confirm whether they are still coming to access the property, reschedule access to the property or cancel access to the property.

9. The property access system of claim 1, wherein the base system further comprises:
a new user interface configured to accept user provided information from a new user; and
a verification module configured to extract identifying information from the user provided information and to retrieve additional identifying information for the new user based on the extracted identifying information;
wherein the base system sends the identifying information to an owner, and enables the owner to choose whether to authorize the new user, and if authorized to schedule an access time for the new authorized user to access the property.

10. A property access method for monitoring access to real property, the method comprising:
scheduling an access time for an authorized user to access the property;
tracking a location of the authorized user using a Global Positioning System (GPS) locator on a mobile electronic device assigned to the authorized user;
sending access information for the property to the mobile electronic device assigned to the authorized user;
notifying a base system when the mobile electronic device arrives at the property based on GPS location readings from the GPS locator on the mobile electronic device; and
notifying the base system when the mobile electronic device departs from the property based on the GPS location readings.

11. The property access method of claim 10, further comprising:
establishing a geofence around the property;
wherein notifying the base system when the mobile electronic device arrives at the property comprises notifying the base system when the GPS location readings indicate the mobile electronic device has crossed into the geofence; and
wherein notifying the base system when the mobile electronic device departs from the property comprises notifying the base system when the GPS location readings indicate the mobile electronic device has crossed out of the geofence.

12. The property access method of claim 10, further comprising:
sending a notification from the base system when the mobile electronic device arrives at the property and departs from the property.

13. The property access method of claim 10, further comprising:
hiding the access information for the property on the mobile electronic device until the GPS location readings indicate that the mobile electronic device has arrived at the property.

14. The property access method of claim 10, further comprising:
hiding the access information for the property on the mobile electronic device until the GPS location readings indicate that the mobile electronic device has arrived at the property, and the current time is within a predetermined window around the access time for the authorized user to access the property.

15. The property access method of claim 10, further comprising:
deleting the access information for the property from the mobile electronic device when the GPS location readings indicate that the mobile electronic device has departed from the property.

16. The property access method of claim 10, further comprising:
establishing a geofence around the property;
wherein notifying the base system when the mobile electronic device arrives at the property comprises notifying the base system when the GPS location readings indicate the mobile electronic device has crossed into the geofence;
wherein notifying the base system when the mobile electronic device departs from the property comprises notifying the base system when the GPS location readings indicate the mobile electronic device has crossed out of the geofence; and
sending a notification from the base system when the mobile electronic device arrives at the property and departs from the property.

17. The property access method of claim 10, further comprising:
checking whether the authorized user has arrived at the property at the scheduled access time; and
when the authorized user has not arrived at the property at the scheduled access time, requesting the authorized user to confirm they are still coming to access the property, reschedule access to the property or cancel access to the property.

18. The property access method of claim 10, further comprising:
accepting user provided information from a new user;
extracting identifying information from the user provided information;
retrieving additional identifying information for the new user based on the extracted identifying information;
sending the identifying information to an owner, and
enabling the owner to choose whether to authorize the new user, and if authorized to schedule an access time for the new authorized user to access the property.

19. A property access method for monitoring access to real property, the method comprising:
scheduling a checkin time and a checkout time for an authorized user to access the property;
tracking a location of the authorized user using a Global Positioning System (GPS) locator on a mobile electronic device assigned to the authorized user;
sending entry information for the property to the mobile electronic device assigned to the authorized user when the current time is at or after the checkin time, and the mobile electronic device has arrived at the property based on GPS location readings from the GPS locator on the mobile electronic device;
notifying a base system when the mobile electronic device arrives at the property based on GPS location readings from the GPS locator on the mobile electronic device;
sending checkout information for the property to the mobile electronic device assigned to the authorized user prior to the checkout time;
removing entry information for the property from the mobile electronic device assigned to the authorized user when the current time is after the checkout time, and the mobile electronic device has departed from the property based on GPS location readings from the GPS locator on the mobile electronic device; and
notifying the base system when the mobile electronic device departs from the property based on the GPS location readings.

20. The property access method of claim, 19, further comprising:
at checkout time, determining whether the authorized user has departed from the property based on GPS location readings from the GPS locator on the mobile electronic device; and
if the authorized user has not departed from the property, sending a checkout reminder for the property to the mobile electronic device assigned to the authorized user, and notifying the base system that the authorized user has not departed from the property.
